(19) United States
(12) Patent Application Publication
(10) Pub. No.: US 2023/0302348 A1
(43) Pub. Date: Sep. 28, 2023

(54) MAGNETIC ALIGNMENT SYSTEM FOR THREE-DIMENSIONAL BUILDING

(71) Applicant: Jason L. Fisher, Blackfoot, ID (US)

(72) Inventor: Jason L. Fisher, Blackfoot, ID (US)

(21) Appl. No.: 18/124,080

(22) Filed: Mar. 21, 2023

Related U.S. Application Data
(60) Provisional application No. 63/323,278, filed on Mar. 24, 2022.

(51) Int. Cl. A63F 3/00; F16B 1/00

(52) U.S. Cl. CPC A63F 3/00697; F16B 1/00; F16B 2001/0035; A63F 2003/00738; A63F 2003/00813

(57) ABSTRACT

A magnetic alignment system for three-dimensional building includes plates with an upper surface and a lower surface, locking members coupleable to the lower surface of the plate, magnetic couplers capable of being removably attachable to the lower surface of the plate via the locking members and fasteners. The plates may be coupled to tiles, with the tiles configured to receive corner fasteners so that cuboidal playing pieces may be created.

### CROSS-REFERENCE TO RELATED APPLICATIONS

This application claims the benefit of U.S. Provisional Application Ser. No. 63/323,278, filed on Mar. 24, 2022, which is incorporated herein by reference.

### TECHNICAL FIELD

The present disclosure relates to a magnetic alignment system. More particularly, the present disclosure relates to a magnetic alignment system for three-dimensional building for, in some instances, table top role-playing games.

### BACKGROUND

Board games have been in existence for thousands of years, with some of the earliest known board games found in ancient Egypt. Not only have board games existed for thousands of years, but role-playing games can also be found in ancient China. Board and role-playing games have existed to test and develop skills, create friendships, provide enjoyment, and to pass time. While role-playing games have been around for thousands of years, table top role-playing games didn't make their appearance until the late 1960s to early 1970s with games such as Dungeons and Dragons.

Most table top role-playing games have various, basic components, which may include a board (e.g., plasticized cardboard), plastic pieces, and cards. The plastic pieces in these games may rest on top of the board or may be coupleable to the board via cutouts therein. With table top role-playing games, many utilize grid map boards for war role-playing games that are made of cardboard. Typical role-playing games lack specialized boards, modularity of pieces, and expandability of terrain systems due to their rudimentary construction. Without these things, some table top role-playing games may be limited in their abilities, may lack excitement for a user, or fail to add the enjoyment necessary to keep customers happy.

Accordingly, there is a need for a modular system that allows components to self-align on a grid and that enables the construction of three-dimensional terrain. The present invention seeks to solve these and other problems.

### SUMMARY OF EXAMPLE EMBODIMENTS

In one embodiment, a magnetic alignment system for three-dimensional building (hereinafter referred to as an “alignment system”) comprises plates with an upper surface and a lower surface, locking members coupleable to the lower surface of the plate, magnetic couplers capable of being removably attachable to the lower surface of the plate via the locking members and fasteners (e.g., screws). The plates may be coupled to tiles, with the tiles configured to receive corner fasteners so that cuboidal playing pieces may be created. Due to the configuration of the magnetic couplers, wall pieces and figurines may couple to the upper surface of the plates and be able to move in half-step increments. The plates and tiles may be coupled together in a variety of ways to create numerous three-dimensional shapes.

### BRIEF DESCRIPTION OF THE DRAWINGS

FIG. 1A illustrates a bottom plan view of a plate of a magnetic alignment system for three-dimensional building;

FIG. 1B illustrates a top plan view of a plate of a magnetic alignment system for three-dimensional building;

FIG. 2A illustrates a top perspective view of a locking member of a magnetic alignment system for three-dimensional building;

FIG. 2B illustrates a bottom perspective view of a locking member of a magnetic alignment system for three-dimensional building;

FIG. 3A illustrates a bottom perspective view of a magnetic coupler of a magnetic alignment system for three-dimensional building;

FIG. 3B illustrates a top perspective view of a magnetic coupler of a magnetic alignment system for three-dimensional building;

FIG. 4A illustrates a top perspective view of a fastener of a magnetic alignment system for three-dimensional building;

FIG. 4B illustrates a bottom perspective view of a fastener of a magnetic alignment system for three-dimensional building;

FIG. 5 illustrates a top perspective view of a tile of a magnetic alignment system for three-dimensional building;

FIG. 6 illustrates a top plan view of a tile with alignment markers coupled thereto;

FIG. 7A illustrates a bottom perspective view of an alignment marker of tiles of a magnetic alignment system for three-dimensional building;

FIG. 7B illustrates a top perspective view of an alignment marker of tiles of a magnetic alignment system for three-dimensional building;

FIG. 8 illustrates a top plan view of a tile with a plate coupled thereto;

FIG. 9A illustrates a bottom perspective view of a corner fastener of a magnetic alignment system for three-dimensional building;

FIG. 9B illustrates a top perspective view of a corner fastener of a magnetic alignment system for three-dimensional building;

FIG. 10 illustrates a perspective view of a cuboidal playing piece of a magnetic alignment system for three-dimensional building;

FIG. 11 illustrates a perspective view of a game piece of a magnetic alignment system for three-dimensional building;

FIG. 12A illustrates a bottom perspective view of a wall coupler of a magnetic alignment system for three-dimensional building;

FIG. 12B illustrates a top perspective view of a wall coupler of a magnetic alignment system for three-dimensional building; and

FIG. 13 illustrates a bottom perspective view of a curved wall piece of a magnetic alignment system for three-dimensional building.

### DETAILED DESCRIPTION OF EXAMPLE EMBODIMENTS

While embodiments of the present disclosure may be subject to various modifications and alternative forms, specific embodiments have been shown by way of example in the drawings and will be described in detail herein. However, the present disclosure is not intended to be limited to the particular features, forms, components, etc. disclosed. Rather, the present disclosure will cover all modifications, equivalents, and alternatives falling within the scope of the present disclosure.

Reference to the invention, the present disclosure, or the like are not intended to restrict or limit the invention, the present disclosure, or the like to exact features or steps of any one or more of the exemplary embodiments disclosed herein. References to “one embodiment,” “an embodiment,” “alternate embodiments,” “some embodiments,” and the like, may indicate that the embodiment(s) so described may include a particular feature, structure, or characteristic, but not every embodiment necessarily includes the particular feature, structure, or characteristic.

Any arrangements herein are meant to be illustrative and do not limit the invention's scope. Although specific terms are employed herein, they are used in a generic and descriptive sense only and not for purposes of limitation. Unless otherwise defined herein, such terms are intended to be given their ordinary meaning not inconsistent with that applicable in the relevant industry and without restriction to any specific embodiment hereinafter described.

It will be understood that the steps of any such processes or methods are not limited to being carried out in any particular sequence, arrangement, or with any particular graphics or interface. In fact, the steps of the disclosed processes or methods generally may be carried out in various, different sequences and arrangements while still being in the scope of the present invention. Certain terms are used herein, such as “comprising” and “including,” and similar terms are meant to be “open” and not “closed” terms. These terms should be understood as, for example, “including, but not limited to.”

As previously described, there is a need for a modular system that allows components to self-align on a grid and that enables the construction of three-dimensional terrain. The present invention seeks to solve these and other problems.

Many role-playing games include various basic components, which may include a board, plastic pieces, and cards. The plastic pieces in these games may rest on top of the board or may be coupleable to the board via cutouts therein. With role-playing games, many utilize grid map boards for war role-playing games that are made of cardboard. Typical role-playing games lack specialized boards, modularity of pieces, and expandability of terrain systems due to their rudimentary construction.

The alignment system described herein provides for modularity of pieces and expandability of terrain systems. The alignment system may include plates with sections, locking members, magnetic couplers, and corner fasteners. The configuration of each component allows a user to build different sizes and shapes of playing pieces. It will be appreciated that the components of the alignment system may be organized in any manner to play a role-playing game. These components may be self-aligned via magnets between the components. It will be appreciated that the system allows a user to create specialized board and customized playing pieces.

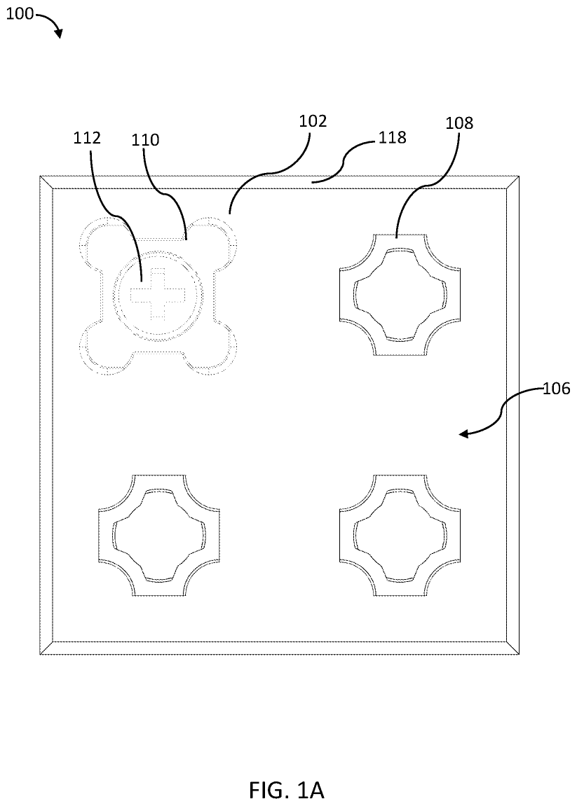

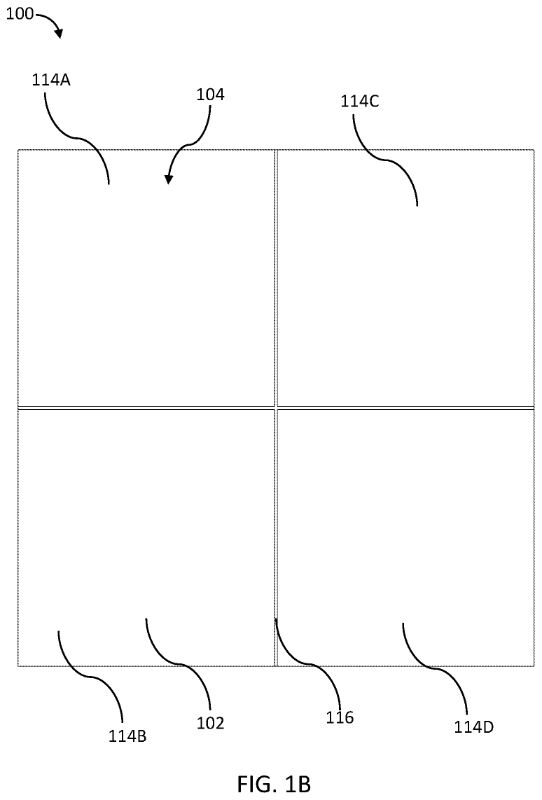

As shown in FIGS. 1A and 1B, in one embodiment, an alignment system 100 comprises plate 102 with an upper surface 104 and a lower surface 106, locking members 108 coupleable to the lower surface 106 of the plate 102, magnetic couplers 110 capable of being removably attachable to the lower surface 106 of the plate 102 via the locking members 108 and fasteners 112 (e.g., screws).

FIGS. 1A and 1B illustrate the plate 102 with the upper surface 104 and lower surface 106. The upper surface 104 may be divided into four sections: a first section 114A, a second section 114B, a third section 114C, and a fourth section 114D, which may be defined by grooves 116 on the upper surface 104. The sections 114A-114D may assist users in playing the role-playing game. While four sections are shown, it will be understood that more or less than four sections may be found on the plate 102. In some embodiments, the upper surface 104 of the plates 102 may comprise markings (e.g., stylized markings to resemble rocks, stone, or other terrain). The edges of the plate 102 may comprise beveled edges 118 so as to be easily coupled to other plates, thereby creating cuboidal-shaped playing pieces. The plate 102 may be manufactured from a variety of materials, such as polypropylene, aluminum, or carbon fiber. Other materials may also be included. Further, the plate 102 may be a variety of sizes in height, depth, and length.

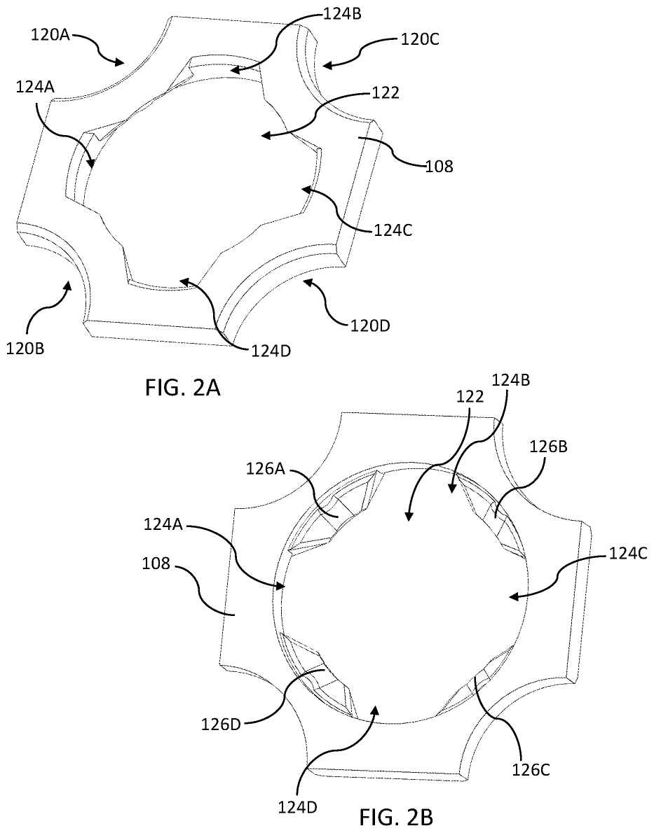

FIGS. 2A and 2B illustrate the locking member 108 of the alignment system 100. The locking members 108, as previously discussed, may be coupled to the lower surface 106 of the plate 102 (shown in FIG. 1A). The locking members 108 may be coupled to the lower surface 106 of the plate 102 via an adhesive (e.g., glue) or any other securement mechanism. The locking members 108 may be positioned so as to be located on the lower surface 106 of each section 114A-114D. While the locking members 108 are shown coupled to the plate 102 in quadrants (FIG. 1A), in some embodiments, the locking members 108 may have a different arrangement on the lower surface 106. Further, in some embodiments, the plate 102 may have one or more locking members 108 on the lower surface 106. The locking member 108 may be generally octagonal-shaped; however, it will be understood that the locking member 108 may have other shapes, such as rectangular or triangular. The locking member 108 may comprise a first, second, third, and fourth notch 120A, 120B, 120C, 120D creating the corners of the locking member 108. The locking member 108 may comprise an aperture 122 with a first aperture, second aperture, third aperture, and fourth aperture notch 124A, 124B, 124C, 124D. In addition, the aperture 122 may comprise a first protrusion 126A between the first and second aperture notches 124A, 124B, a second protrusion 126B between the second and third aperture notches 124B, 124C, a third protrusion 126C between the third and fourth aperture notches 124C, 124D, and a fourth protrusion 126D between the fourth and first aperture notches 124D, 124A. The first, second, third, and fourth protrusions 126A-126D may be angled so as to receive the fastener 112. The locking member 108 is configured to receive the magnetic coupler 110 and the fastener 112.

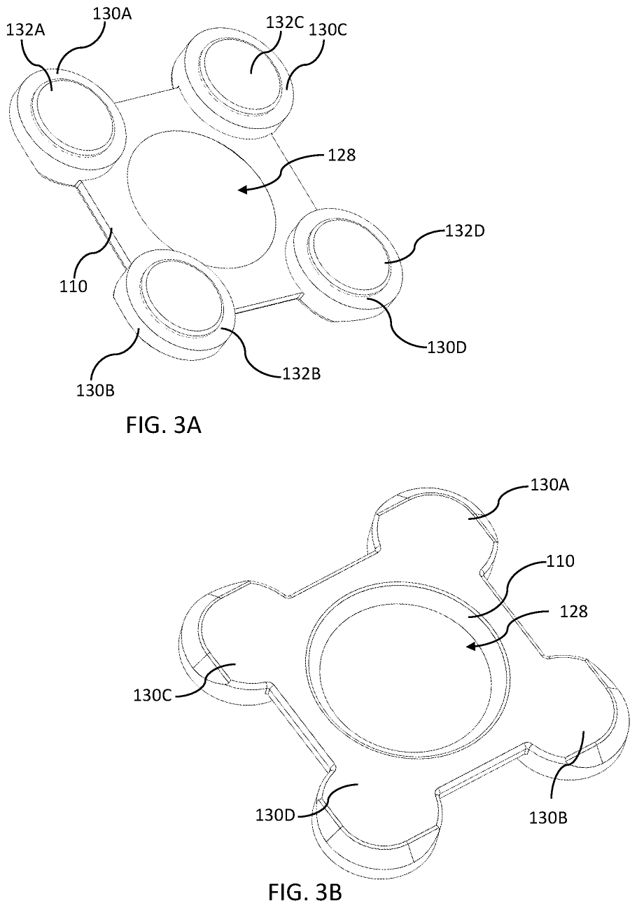

FIGS. 3A and 3B illustrate magnetic couplers 110 that may be received by the locking member 108. In particular, the magnetic coupler 110 may be generally square-shaped, but it will be understood that the magnetic coupler 110 is not limited to being square-shaped. The magnetic coupler 110 may comprise a fastener aperture 128 to receive the fastener 112 so as to be coupled to the locking member 108. In particular, the magnetic coupler 110 may comprise a beveled edge that circumscribes the fastener aperture 128 so as to receive the fastener 112. The magnetic coupler 110 may comprise a first corner 130A, a second corner 130B, a third corner 130C, and a fourth corner 130D. The first, second, third, and fourth corners 130A-130D may be rounded. Other embodiments may have non-rounded corners. The first, second, third, and fourth corners 130A-130D may each comprise a recession to receive a magnet 132A, 132B, 132C, 132D, or in some embodiments, other types of securement mechanisms.

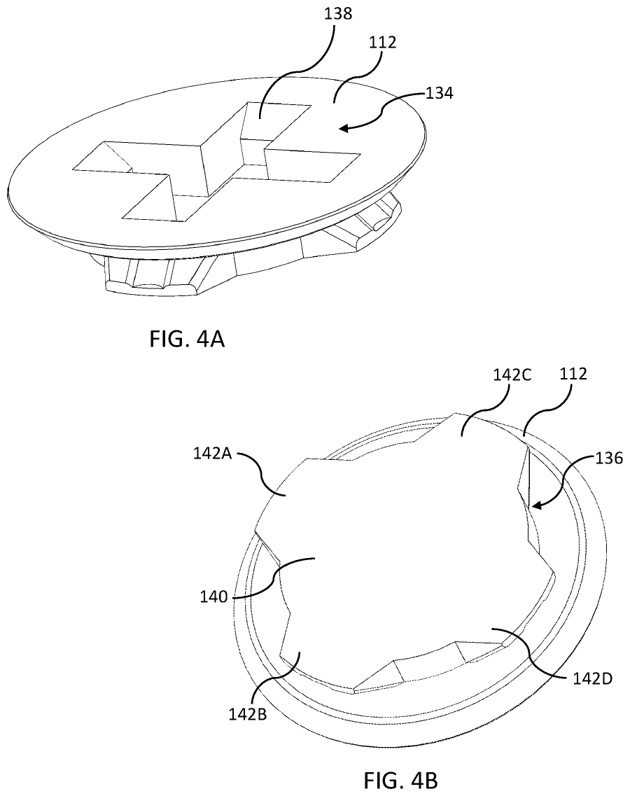

FIGS. 4A and 4B illustrate the fastener 112 that couples the magnetic coupler 110 to the locking member 108 and ultimately, the plate 102. The fastener 112 may have an upper surface 134 and a lower surface 136. The upper surface 134 may comprise a plus-shaped recessed marking 138 to receive a phillips screw driver or a flat head screwdriver. In some embodiments, the upper surface 134 may comprise a recessed marking to receive an Allen wrench/hex key or other receiving recessions. The lower surface 136 may comprise a protrusion 140 with a first finger 142A, second finger 142B, third finger 142C, and a fourth finger 142D. To couple the magnetic coupler 110 to the locking member 108, the first, second, third, and fourth corners 130A-130D of the magnetic coupler 110 may be positioned in the first, second, third, and fourth notches 120A-120D of the locking member 108. The fastener 112 may then be placed in the fastener aperture 128 on the magnetic coupler 110. The first, second, third, and fourth fingers 142A-142D may engage with the first, second, third, and fourth aperture notches 124A-124D on the locking member 108 so that when the fastener 112 is turned the first, second, third, and fourth fingers 142A-142D move underneath the first, second, third, and fourth protrusions 126A-126D in the aperture 122 of the locking member 108, thereby securing the magnetic coupler 110 to the locking member 108.

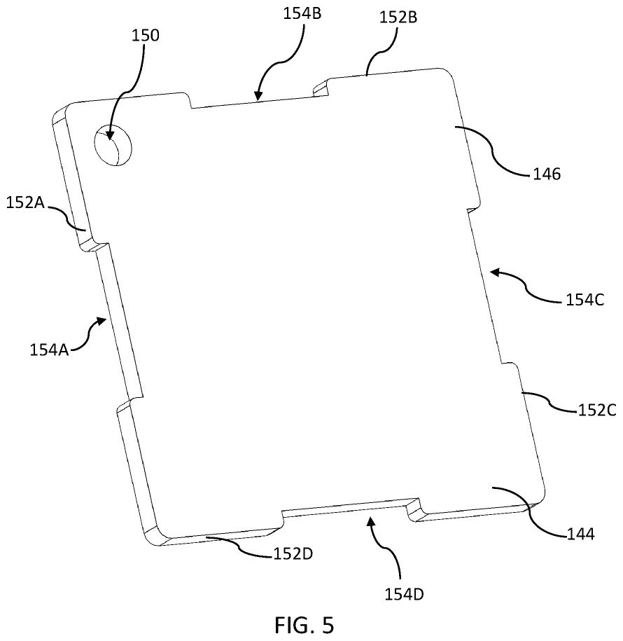

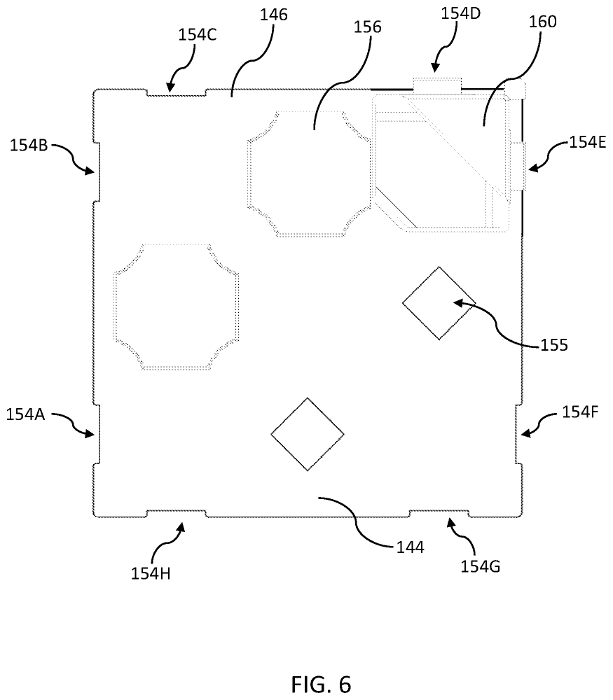

FIGS. 5-6 illustrate a tile 144 that may be manufactured from a ferromagnetic material, such as iron, nickel, or cobalt. The tile 144 may be square-shaped, or any other shape, such as rectangular. The tile 144 may be of a variety of sizes, such as a first size 146 and a second size 148. The first size 146 may be smaller than the second size 148. While two tile sizes are shown, there may be numerous sizes and shapes of tiles. The tile 144 may comprise a tile aperture 150. Further, the tile 144 may comprise a first side edge 152A, a second side edge 152B, a third side edge 152C, and a fourth side edge 152D, with each edge comprising an edge notch 154A-154D. Depending on the size of the tile 144, the tile 144 may have more or less than four edge notches. It will be appreciated that the tile 144 may receive one or more plates 102. The tile 144 may, in some embodiments, include magnets.

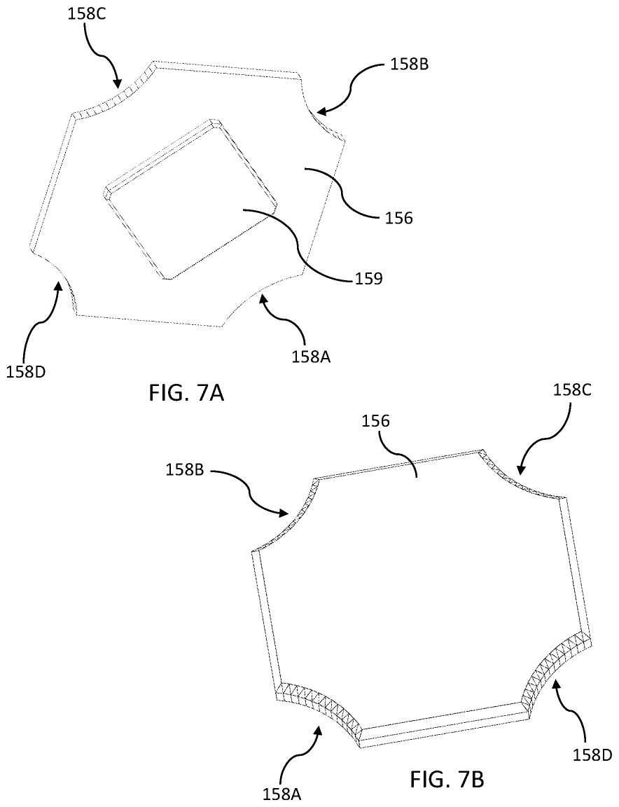

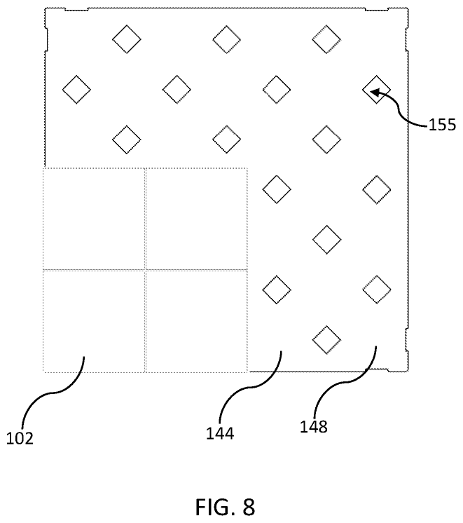

The tile 144 may also comprise tile apertures 155 that receive alignment markers 156 that may be coupled to the tile 144 in a pattern. The alignment markers 156 may be raised from a surface of the tile 144 so as to not be flush with the tile 144. As shown in FIGS. 7A and 7B, the alignment markers 156 may be octagonal-shaped, similar in shape to the locking member 108, with a first marker notch 158A, a second marker notch 158B, a third marker notch 158C, and a fourth marker notch 158D. A lower surface of the alignment markers 156 may comprise a protrusion 159 (e.g., a key) that mirrors the shape of the tile apertures 155. As such, the protrusion 159 of the alignment markers 156 may be inserted into the tile apertures 155 on each side of the tile 144. With alignment markers 156 inserted into the tile apertures 155 on each side, protrusions 159 will contact each other in the tile apertures 155, thereby being secured therein. The corners 130A-130D of the magnetic couplers 110 may be positioned in the marker notches 158A-158D and assist in self-alignment (shown in FIG. 1). Referring to FIG. 8, the plate 102 may be positioned on the tiles 144 and be quickly aligned via the alignment markers 156. Also, the magnetic couplers 110 have magnets that are spaced so as to be aligned with the alignment markers 156. The alignment system 100 allows modular assembly of metal structures as large as desired, which can then be covered with other pieces that follow the same system. The plates 102 may align in numerous ways on the tile 144. Multiple tiles 144 may be coupled together and the plate 102 may then be positioned over the tiles 144.

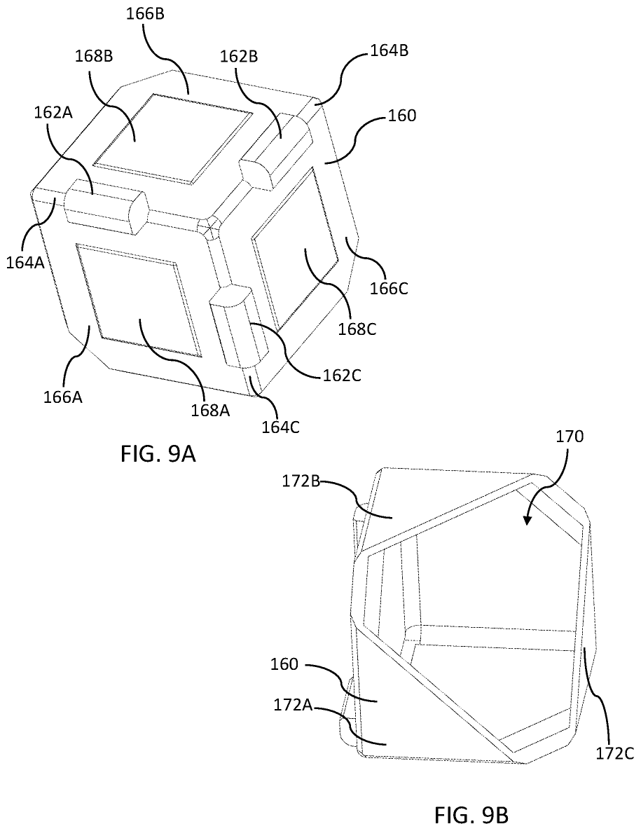

FIGS. 9A-9B illustrate a corner fastener 160 that allows multiple tiles 144 to be configured in cube-shaped playing pieces. The corner fastener 160 may comprise a first protrusion 162A on a first edge 164A, a second protrusion 162B on a second edge 164B, and a third protrusion 162C on a third edge 164C. The first, second, and third protrusions 162A-162C may be positioned in the edge notches 154A-154D (or other notches depending on the size of the tile) of the tiles 144 so as to assist in alignment of the various pieces of the alignment system 100. The corner fastener 160 may be cuboidal shaped. Other shapes may be envisioned, such as rectangular. A first panel 166A, second panel 166B, and third panel 166C of the corner fastener 160 may each comprise a magnet 168A, 168B, 168C positioned therein. In some embodiments, the magnet 168A-168C may be positioned in a recessed area in each of the first, second, and third panels 166A-166C. On a side opposite the first, second, and third panels 166A-166C, the corner fastener 160 may comprise an aperture 170, so as to decrease material and weight of the corner fastener 160. The aperture 170 may be defined by a first triangular panel 172A, a second triangular panel 172B, and a third triangular panel 172C each of which is coupled to at least two panels 166A-166C.

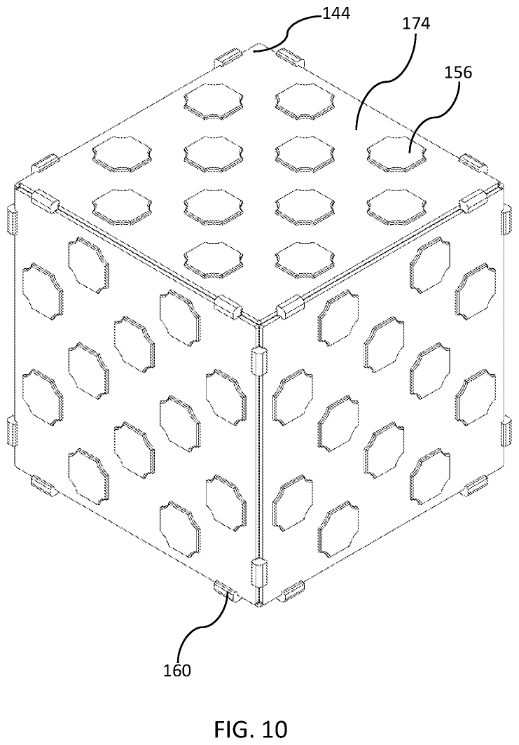

As shown in FIG. 10, to utilize the corner fasteners 160, the corner fasteners 160 may be coupled to tiles 144, with the first, second, and/or third protrusions 162A-162C positioned in the edge notches 154A-154D, or as shown in FIG. 6 edge notches 154A-154H, of the tile 144 and with the magnets 168A-168C coupling the corner fasteners 160 to the tile 144. As an example, four corner fasteners 160 may be positioned on a single tile. Once the four corner tiles 160 are positioned on a single, base tile 144, other tiles acting as sidewalls may be positioned around the base tile 144 and couple to the corner fasteners 160. Additional corner fasteners 160 may be positioned at a top of the tiles acting as sidewalls. Then a top tile 144 may be positioned on the corner fasteners 160, thereby forming a cuboidal-shaped playing piece 174. It will be appreciated that by using this system 100, any shape of playing piece may be created, such as rectangular. It will further be appreciated that tiles and plates, when coupled together or separate, may be coupled and aligned in every position, whether horizontal or vertical.

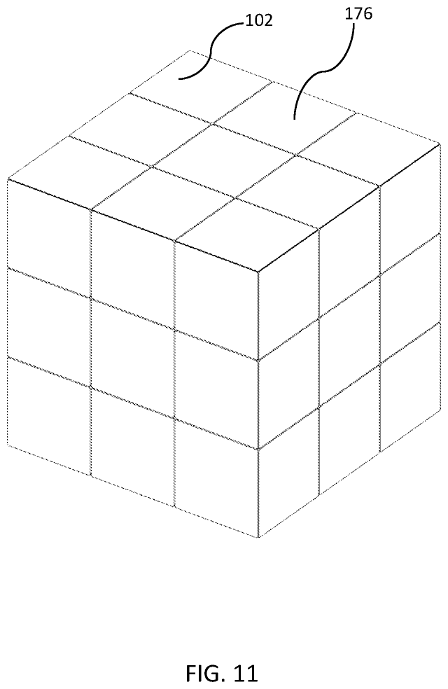

In some embodiments, after the cuboidal shaped playing piece 174 is formed, a second magnetic coupler may be positioned on any of the tiles utilizing the alignment markers, thereby allowing multiple cuboidal shaped playing pieces, or other playing pieces, to be coupled together. Each side of the cuboidal playing pieces 174 may receive plates 102 to create a game piece 176 as shown in FIG. 11. In some embodiments, the game piece 176 may be configured to receive a playing figurine and any other game pieces for playing a game, which playing pieces may be utilized on the game piece 176, plates 102, or any other configuration. The playing figurine may comprise a magnet on a bottom of the figurine. The figurine magnet can interact with the four magnets on the magnetic coupler 110 positioned below the plate 102, and it is capable of aligning itself to any of the sections on the plate 102. Accordingly, due to the configuration of the figurine and the plates 102, the figurine is capable of half-step increments as desired during game play. That is, the figurine may be positioned in any section of the plate 102 or may be positioned so as to cover a half of two sections, or cover a quarter of four sections if placed at the junction of the four sections 114A-114D.

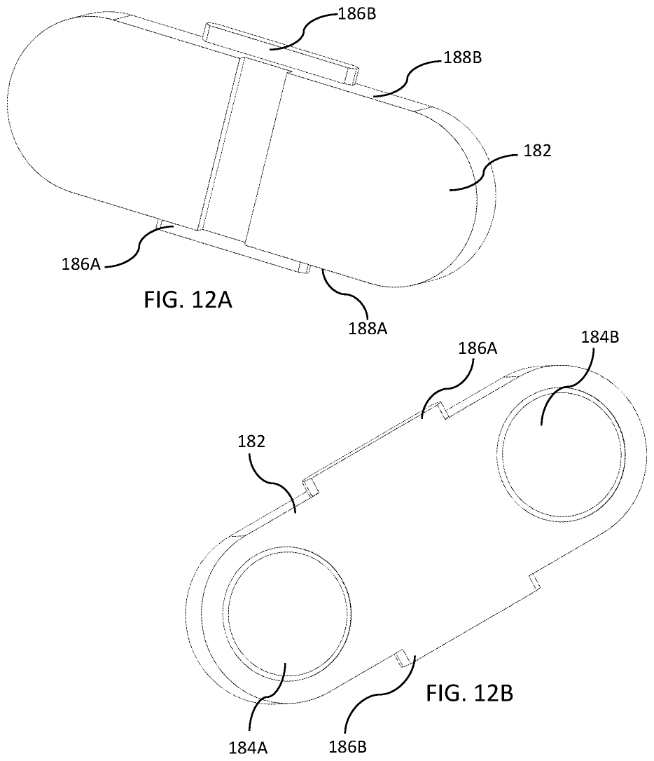

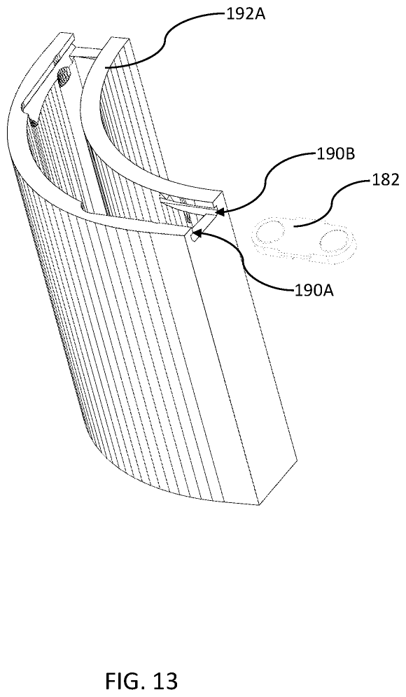

FIGS. 12A and 12B illustrate wall couplers 182. The first wall coupler 182 may comprise a first magnet 184A and a second magnet 184B on an upper surface. The wall coupler 182 may comprise a first protrusion 186A on a first edge 188A and a second protrusion 186B on a second edge 188B, with both of the protrusions 186A, 186B capable of interacting with channels 190A, 190B on a wall piece 192 (e.g., a corner wall piece) as shown in FIG. 13. While the wall piece 192 shown in FIG. 13 is a curved, corner wall piece, any size or shape of wall piece may be used, such as a straight wall piece. In some embodiments, a second wall coupler may comprise a third magnet at a first end and a fourth magnet at a second end. The second wall coupler may comprise various apertures interposed between the first end and the second end. The second wall coupler may slide into the channels 190A-190B on a bottom portion of a straight wall piece so as to be secured therein. After the second wall coupler is positioned in the channels, at least one first wall coupler 182 may also slide into the channels 190A-190B, interacting with and resting upon the second wall coupler. It will be appreciated that the first wall coupler 182 provides vertical and horizontal stability as well as alignment of the wall piece 192 along the plates 102. The wall piece may align on the sections 114A-114D (FIG. 1B) of the plates 102 easily and in the correct positions via the interactions of the various different magnets, especially the magnetic couplers 110 positioned on a lower surface of the plates 102. It will be appreciated that the wall piece may align itself in half-step increments on the sections 114A-114D of the plate 102.

The curved wall piece 192 with the first wall coupler 182 positioned at a first end and another first wall coupler 182 positioned at a second end. The first wall couplers 182 may couple to the curved wall piece 192 via channels 190A-190B. The curved wall piece 192B may interact with the magnetic couplers 110 attached to the plates 102. It will be understood that the system is compatible with numerous tile designs, sizes, shapes, etc. These numerous designs may be combined together to create a wide variety of configurations. For example, the alignment system may not only be limited to square-shaped designs, but may also utilize 45-degree slopes, or any other type of angled piece.

In some embodiments, the alignment system 100 may comprise a sheet of material with magnets embedded therein at distances that will align the components of the system 100, such as the magnetic couplers 110. Accordingly, the sheet of material would allow a user to couple a tile thereto without having to couple the tile to another tile in the alignment system 100 or to a metal tile with the alignment markers 156. As an example, a user may want to couple the components to a wet-erase battle map.

It will be appreciated that the alignment system 100 may expand the functionality of grid maps, such as ones commonly used for combat in role-playing game settings. It will further be appreciated that the alignment system 100 automatically aligns components to the plates to provide stability of pieces attached, offers modularity, and expandability of terrain systems. With the alignment system 100 discussed above, it will also be understood that the system is not limited to any particular size or shape of pieces or magnets, may use different strengths of magnets, and that the magnets may, in some embodiments, be embedded into the pieces or have a different connection system.

It will be understood that while various embodiments have been disclosed herein, other embodiments are contemplated. Further, systems and/or methods according to certain embodiments of the present disclosure may include, incorporate, or otherwise comprise properties or features described in other embodiments. Consequently, various features of certain embodiments can be compatible with, combined with, included in, and/or incorporated into other embodiments of the present disclosure. Therefore, disclosure of certain features or components relative to a specific embodiment of the present disclosure should not be construed as limiting the application or inclusion of said features or components to the specific embodiment unless stated. As such, other embodiments can also include said features, components, members, elements, parts, and/or portions without necessarily departing from the scope of the present disclosure.

The embodiments described herein are examples of the present disclosure. Accordingly, unless a feature or component is described as requiring another feature or component in combination therewith, any feature herein may be combined with any other feature of a same or different embodiment disclosed herein. Although only a few of the example embodiments have been described in detail herein, those skilled in the art will appreciate that modifications are possible without materially departing from the present disclosure described herein. Accordingly, all modifications may be included within the scope of this invention.

What is claimed is:

1. A magnetic alignment system for three-dimensional building comprising:
plates comprising an upper surface with one or more sections and a lower surface;
locking members coupleable to the lower surface of the plate;
magnetic couplers coupleable to the locking members via fasteners;
tiles comprising alignment markers that receive the plates with the magnetic couplers;
corner fasteners that are coupled to the tiles to form cuboidal playing pieces.

2. The magnetic alignment system for three-dimensional building of claim 1, wherein the plates comprise a polypropylene material.

3. The magnetic alignment system for three-dimensional building of claim 1, wherein the locking members are coupled to the plates with an adhesive.

4. The magnetic alignment system for three-dimensional building of claim 1, wherein each of the plates comprises a first section, a second section, a third section, and a fourth section.

5. The magnetic alignment system for three-dimensional building of claim 4, wherein the first section, the second section, the third section, and the fourth section are defined by grooves on an upper surface of the plates.

6. The magnetic alignment system for three-dimensional building of claim 1, wherein the plates comprise beveled edges to allow the construction of a game piece.

7. The magnetic alignment system for three-dimensional building of claim 1, wherein the locking members comprise a first notch, a second notch, a third notch, and a fourth notch, creating corners of the locking members.

8. The magnetic alignment system for three-dimensional building of claim 1, wherein the locking members comprise an aperture.

9. The magnetic alignment system for three-dimensional building of claim 1, wherein the locking members comprise a first aperture notch, a second aperture notch, a third aperture notch, and a fourth aperture notch.

10. The magnetic alignment system for three-dimensional building of claim 9, wherein a first protrusion is interposed between the first and second aperture notches, a second protrusion is interposed between the second and third aperture notches, a third protrusion is interposed between the third and fourth aperture notches, and a fourth protrusion is interposed between the fourth and first aperture notches.

11. The magnetic alignment system for three-dimensional building of claim 10, wherein the fasteners comprise a protrusion with a first finger, a second finger, a third finger, and a fourth finger that interact and engage with the first, second, third, and fourth aperture notches and the first, second, third, and fourth protrusions.

12. The magnetic alignment system for three-dimensional building of claim 1, wherein the magnetic couplers comprise a fastener aperture.

13. The magnetic alignment system for three-dimensional building of claim 1, wherein the magnetic couplers comprise a first corner with a first magnet, a second corner with a second magnet, a third corner with a third magnet, and a fourth corner with a fourth magnet.

14. The magnetic alignment system for three-dimensional building of claim 1, wherein the tiles comprise a ferromagnetic material.

15. The magnetic alignment system for three-dimensional building of claim 1, further comprising alignment markers that couple to an upper and lower surface of the tiles.

16. A magnetic alignment system for three-dimensional building comprising:
plates comprising an upper surface with one or more sections and a lower surface;
locking members coupleable to the lower surface of the plate, the locking members comprising:
a first notch, a second notch, a third notch, and a fourth notch, creating corners of the locking member;
a first aperture notch, a second aperture notch, a third aperture notch, and a fourth aperture notch; and
a first protrusion interposed between the first and second aperture notches, a second protrusion interposed between the second and third aperture notches, a third protrusion interposed between the third and fourth aperture notches, and a fourth protrusion interposed between the fourth and first aperture notches;
magnetic couplers coupleable to the locking members via fasteners, the magnetic couplers comprising:
a first corner with a first magnet, a second corner with a second magnet, a third corner with a third magnet, and a fourth corner with a fourth magnet,
wherein the first corner, second corner, third corner, and fourth corner are positioned in the first notch, the second notch, the third notch, and the fourth notch of the locking members;
tiles comprising alignment markers to receive the plates with the magnetic couplers;
corner fasteners that are coupled to the tiles to form cuboidal playing pieces.

17. The magnetic alignment system for three-dimensional building of claim 16, wherein the tiles comprise edge notches.

18. The magnetic alignment system for three-dimensional building of claim 17, wherein the corner fasteners comprise a first corner protrusion on a first edge, a second corner protrusion on a second edge, and a third corner protrusion on a third edge, wherein the first, second, and third corner protrusions mate with the edge notches.

19. The magnetic alignment system for three-dimensional building of claim 18, wherein the corner fasteners comprise a first panel, a second panel, and a third panels, each of the panels comprising a magnet.

20. A magnetic alignment system for three-dimensional building comprising:
plates comprising an upper surface with one or more sections and a lower surface;
locking members coupleable to the lower surface of the plate, the locking members comprising:
a first notch, a second notch, a third notch, and a fourth notch, creating corners of the locking members;
a first aperture notch, a second aperture notch, a third aperture notch, and a fourth aperture notch; and
a first protrusion interposed between the first and second aperture notches,
a second protrusion interposed between the second and third aperture notches, a third protrusion interposed between the third and fourth aperture notches, and a fourth protrusion interposed between the fourth and first aperture notches;
magnetic couplers coupleable to the locking members via fasteners, the magnetic couplers comprising:
a first corner with a first magnet, a second corner with a second magnet, a third corner with a third magnet, and a fourth corner with a fourth magnet,
wherein the first corner, second corner, third corner, and fourth corner are positioned in the first notch, the second notch, the third notch, and the fourth notch;
tiles comprising alignment markers to receive the plates with the magnetic couplers;
corner fasteners that are coupled to the tiles to form cuboidal playing pieces, the corner fastener comprising:
a first corner protrusion on a first edge, a second corner protrusion on a second edge, and a third corner protrusion on a third edge.
